(19) United States
(12) Patent Application Publication
(10) Pub. No.: US 2018/0366859 A1
(43) Pub. Date: Dec. 20, 2018

(54) ELECTRICAL CONNECTOR

(71) Applicant: DAI-ICHI SEIKO CO., LTD., Kyoto-shi (JP)

(72) Inventor: Hikaru Naoi, Shizuoka-shi (JP)

(21) Appl. No.: 15/993,104

(22) Filed: May 30, 2018

(30) Foreign Application Priority Data
Jun. 15, 2017 (JP) 2017-117810

(51) Int. Cl. H01R 13/422

(52) U.S. Cl. CPC H01R 13/4223

(57) ABSTRACT

An electrical connector includes: a housing that has a tubular housing chamber; and a terminal that is placed in the housing chamber. The terminal includes a protrusion protruding in a direction orthogonal to a direction in which the terminal is inserted into the housing chamber. The housing includes: a guide groove that is disposed on an inner wall of the housing chamber and guides the protrusion when the terminal is inserted into the housing chamber; and an inverse insertion preventing portion that interferes with the protrusion when the terminal is inserted upside down into the housing chamber. The inverse insertion preventing portion is disposed at an insertion point through which the terminal is inserted into the housing chamber.

### CROSS-REFERENCE TO RELATED APPLICATION

This application claims the benefit of Japanese Patent Application No. 2017-117810, filed on Jun. 15, 2017, the entire disclosure of which is incorporated by reference herein.

### FIELD OF THE INVENTION

This application relates to an electrical connector.

### BACKGROUND OF THE INVENTION

One known electrical connector includes an insulative housing that defines a housing chamber and a terminal that is retained in the housing when contained in the housing chamber.

In the electrical connector disclosed in Unexamined Japanese Patent Application Kokai Publication No. H05-190228, a stabilizer is disposed so as to protrude from the surface of the terminal, and an inverse-insertion preventing wall is disposed inside the housing chamber in the housing. Hence, in the event that the terminal is inserted upside down into the housing chamber in the housing during assembly of an electrical connector, the stabilizer abuts on the inverse-insertion preventing wall in the housing, and thus inverse insertion is prevented.

The electrical connector disclosed in Unexamined Japanese Patent Application Kokai Publication No. H05-190228, however, allows any terminal turned upside down to be inserted into a housing chamber until the stabilizer abuts on the inverse-insertion preventing wall. This creates a burden of removing the upside-down terminal and reinserting the terminal with the correct side up. In addition, removing the upside-down terminal may damage an inner wall of the housing chamber in the housing. Therefore, it is not easy to assemble the aforementioned electrical connector.

The present disclosure has been created in view of the foregoing circumstances, and an objective of the disclosure is to provide an electrical connector that can be easily assembled.

### SUMMARY OF THE INVENTION

To achieve the aforementioned objective, an electrical connector according the present disclosure includes: a housing that includes a tubular housing chamber; and a terminal that is placed in the housing chamber. The terminal includes a protrusion protruding in a direction orthogonal to a direction in which the terminal is inserted into the housing chamber. The housing includes: a guide groove that is disposed on an inner wall of the housing chamber and that guides the protrusion when the terminal is inserted into the housing chamber; and an inverse insertion preventing portion that interferes with the protrusion when the terminal is inserted upside down into the housing chamber. The inverse insertion preventing portion is disposed at an insertion point through which the terminal is inserted into the housing chamber.

The terminal may include a body to be in contact with a mating terminal, the housing chamber may include the guide groove extending in an insertion direction, and the protrusion may be disposed on the body.

A plurality of the protrusions may be placed along a direction in which the terminal is inserted.

The terminal may include a lance-lock portion, the housing may include a lance protruding from an inner wall of the housing chamber, and the lance may lock the lance-lock portion when the terminal is inserted into the housing chamber.

The housing may include a lance protruding from the guide groove in the housing chamber, and the lance may lock the protrusion when the terminal is inserted into the housing chamber.

According to the present disclosure, the inverse insertion preventing portion disposed at the insertion point interferes with the protrusion when the terminal is inserted upside down into the housing chamber. This prevents the upside-down terminal from being inserted into the housing chamber. Therefore, an easy-to-assemble electrical connector can be provided.

### BRIEF DESCRIPTION OF THE DRAWINGS

A more complete understanding of this application can be obtained when the following detailed description is considered in conjunction with the following drawings, in which:

FIG. 1A is a front view of an electrical connector according to an embodiment of the present disclosure;

FIG. 1B is a cross-sectional view taken along A-A in FIG. 1A;

FIG. 2A illustrates a terminal according to an embodiment of the present disclosure;

FIG. 2B is a side view of the terminal according to the embodiment;

FIG. 2C is a cross-sectional view of the terminal according to the embodiment;

FIG. 3A illustrates a housing according to an embodiment of the present disclosure;

FIG. 3B is a view of the housing according to the present disclosure seen from the insertion point;

FIG. 4 is a cross-sectional view of the housing according to the embodiment;

FIG. 5 is a partial cross-sectional view of the housing according to the embodiment;

FIG. 6A is a view showing that the terminal is going to be inserted into the housing according to the embodiment;

FIG. 6B is a cross-sectional view showing that the terminal is being inserted into the housing according to the embodiment;

FIG. 6C is a schematic view intended to explain operation of a guide groove;

FIG. 7A is a view showing that the terminal is going to be inserted upside down into the housing according to the embodiment;

FIG. 7B is a cross-sectional view showing that the terminal is being inserted upside down into the housing according to the embodiment;

FIG. 7C is a schematic view intended to explain operation of the inverse insertion preventing portion;

FIG. 8A is a front view of an electrical connector according to a variation; and

FIG. 8B is a cross-sectional view taken along B-B in FIG. 8A.

### DETAILED DESCRIPTION OF INVENTION

An electrical connector according to an embodiment of the present disclosure will now be described with reference to the drawings.

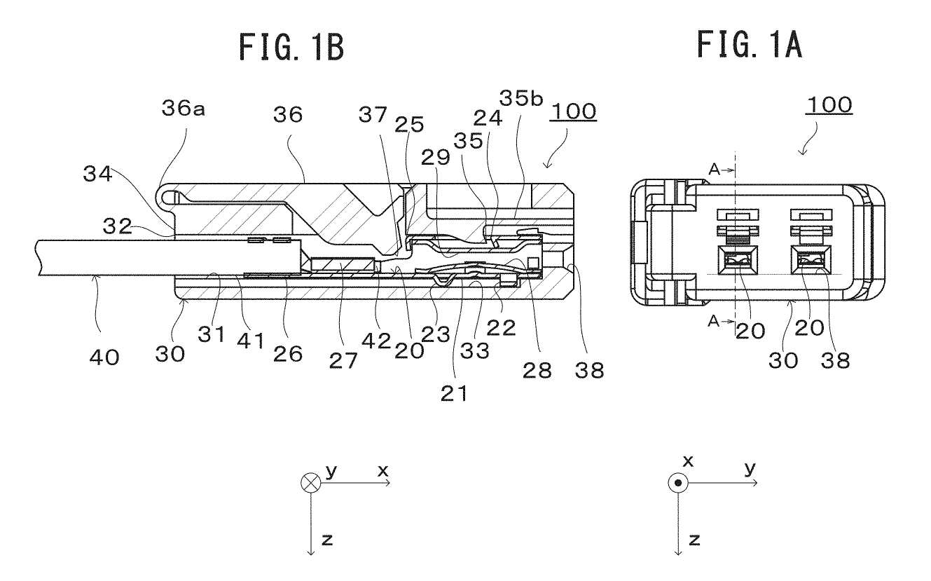

The electrical connector 100 according to the present invention is used as a component of an electronic circuit mounted in a car, the electrical connector 100 including a pair of terminals 20 and an insulative housing 30 in which the terminals 20 are placed, as illustrated in FIGS. 1A and 1B.

For ease of understanding, an orthogonal coordinate system is applied to the drawings and referred to as appropriate, where the x-axis represents the direction in which the terminals 20 are inserted, the y-axis represents the direction along which the terminals 20 are arranged, and the z-axis direction is perpendicular to the x-axis and y-axis directions.

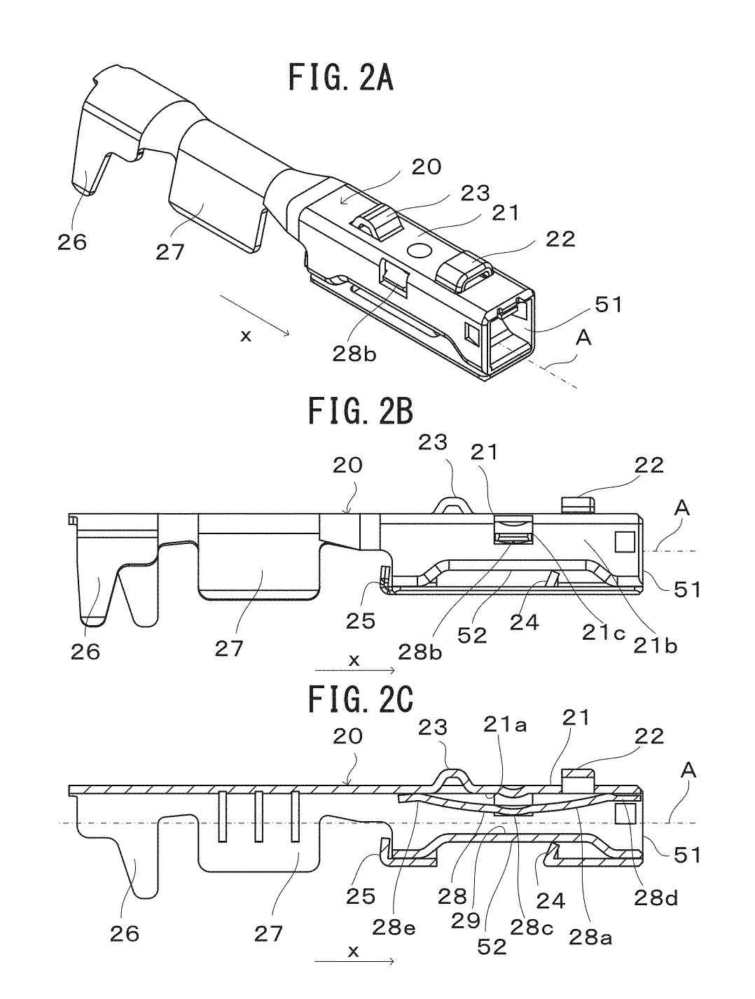

The terminal 20 is a female terminal formed by bending an electrically conductive member such as a metal plate. As illustrated in FIGS. 2A to 2C, the terminal 20 includes a square-tubular body 21 to be in contact with a mating terminal, a first stabilizer 22 and a second stabilizer 23, each of which is a protrusion disposed on the body 21 and protruding in a direction orthogonal to the direction in which the terminal is inserted into a housing chamber, a lance-lock portion 24, a lock portion 25, a fastening portion 26 for fastening an insulator 41 of a conductive wire 40, a binding portion 27 for crimp-fastening a conductor 42 of the conductive wire 40, an arch-shaped resilient contact 28 disposed on an inner wall of the body 21, and a contact 29 facing the resilient contact 28.

The body 21, into which a male terminal (not illustrated), the female terminal's counterpart, is to be inserted in the −x axis direction, is made by bending a metal plate into a square-tubular shape. On the front end of the body 21, an opening 51 is provided to accept the inserted male terminal. On the top face of the body 21, the first and second stabilizers 22 and 23 are disposed so as to protrude in a direction away from the axial center A of the body 21. The first and second stabilizers 22 and 23 each are formed by making two cuts in the metal plate and striking out the area between the cuts from inside. The first and second stabilizers 22 and 23 prevent the terminal 20 turned upside down from entering the housing 30, as well as stabilizing the terminal 20 that has been inserted into the housing 30. The first stabilizer 22 is placed closer to the front end of the body 21 (on the +x direction) than the second stabilizer 23.

The lance-lock portion 24 is disposed on a recess 52 formed in the body 21, and includes a planar slope inclined in a direction away from the axial center A of the body 21 as the slope comes closer to the base end away from the front end of the body 21. The lock portion 25 is disposed on the base end of the body 21, and includes a planar slope inclined in a direction away from the axial center A of the body 21 as the slope comes closer to the base end away from the front end of the body 21.

The fastening portion 26 and the binding portion 27 each include a pair of resilient cantilevers. The fastening portion 26 is plastically deformed to fasten the insulator 41 of the conductive wire 40. The binding portion 27, which electrically connects the conductor 42 of the conductive wire 40 to the terminal 20, is crimped with a crimping tool to fasten the conductor 42 of the conductive wire 40.

The resilient contact 28 includes an arch-shaped plate spring placed on a ceiling face 21a along the longitudinal direction (x-axis direction) of the body 21. The resilient contact 28 includes an arch-shaped plate spring 28a, a tab 28b protruding laterally (along the y-axis direction) from either side of the plate spring 28a at its center, and a projection 28c formed on the plate spring 28a at the position of the tab 28b to come into contact with a male terminal. The resilient contact 28 is prevented from being displaced toward the contact 29, because the front end 28d and the rear end 28e are supported on the ceiling face 21a of the body 21 and each of the tabs 28b disposed in the middle is caught in a cutout 21c formed in either side wall 21b of the body 21. Hence, the resilient contact 28 functions as an arch-shaped plate spring in spite of the front and rear ends 28d end 28e being free ends. When inserted, the male terminal is held between the resilient contact 28 and the contact 29 that is placed to face the resilient contact 28.

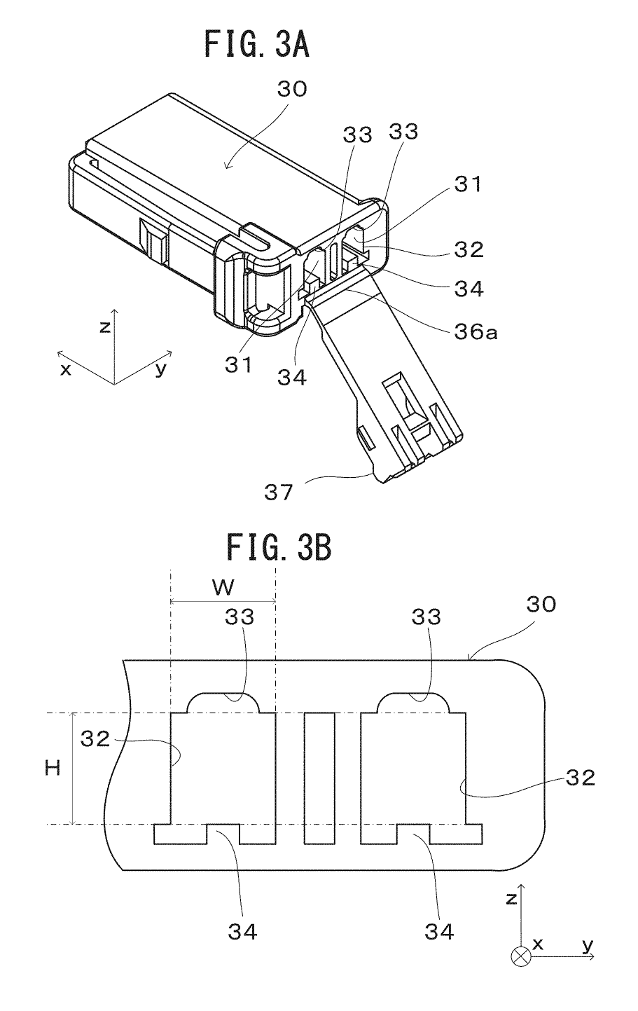

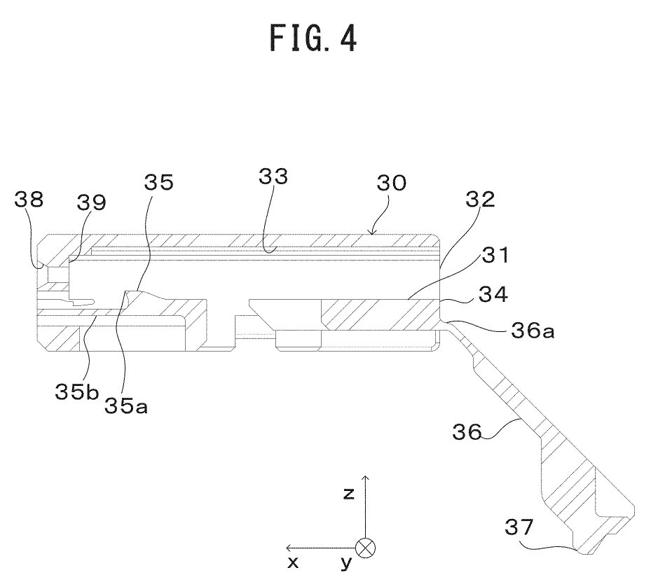

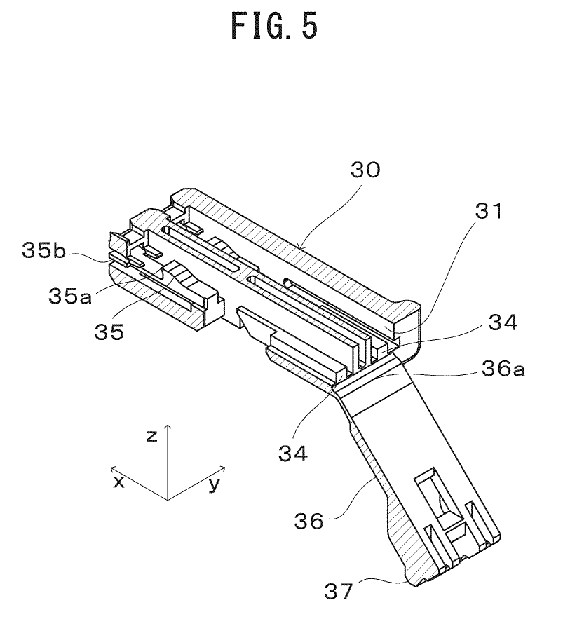

The housing 30 is formed of a resin. As illustrated in FIGS. 3 to 5, the housing 30 includes a pair of housing chambers 31 each in a tubular shape, an insertion point 32 through which the terminal 20 is inserted, a guide groove 33 to engage the first and second stabilizers 22 and 23 when the terminal 20 is inserted, an inverse insertion preventing portion 34 to abut on the first stabilizer 22 when the terminal 20 is inserted upside down, a lance 35 protruding from an inner wall of the housing chamber 31, and a holding portion 37 disposed on an arm 36. Note that some members are omitted in FIG. 3B for convenience of explanation.

The housing chamber 31, which is in a tubular shape for housing the terminal 20, includes the insertion point 32 disposed on one end, an insertion hole 38 disposed on the other end through which the male terminal (not illustrated) is to be inserted, and an abutment 39 to abut on the front end of the terminal 20. The insertion point 32 is formed so that its height H from the top face of the inverse insertion preventing portion 34 to the ceiling, as indicated in FIG. 3B, is slightly greater than the height (the length along the z-axis direction) of the body 21. Likewise, the insertion point 32 is formed so that its width W (the length between the side walls) is slightly greater than the width of the body 21. The guide groove 33 includes a groove extending in a direction (+x direction) in which the terminal 20 is inserted. The inverse insertion preventing portion 34 is disposed at the insertion point 32 of the housing chamber 31. The lance 35 includes a claw 35a formed into a sharp tip pointing in the x-axis direction to lock the terminal 20 and a resilient sheet 35b extending from the claw 35a and connected to one end of the housing 30 to resiliently deform. The holding portion 37 is disposed on one end of the arm 36 to hold the lock portion 25 of the terminal 20. The other end of the arm 36 is connected to the other end of the housing via a hinge 36a.

The following describes a method for assembling the electrical connector 100 referring to the drawings.

First, as shown in FIG. 1B, the conductor 42 of the conductive wire 40 is crimped onto the binding portion 27, and the insulator 41 is fastened to the fastening portion 26. In this way, the conductive wire 40 is attached to the terminal 20.

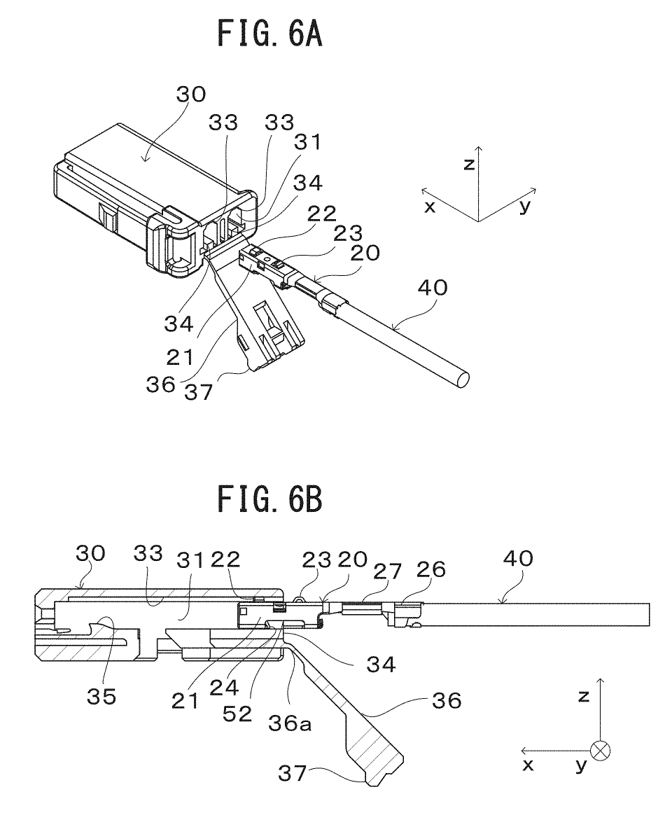

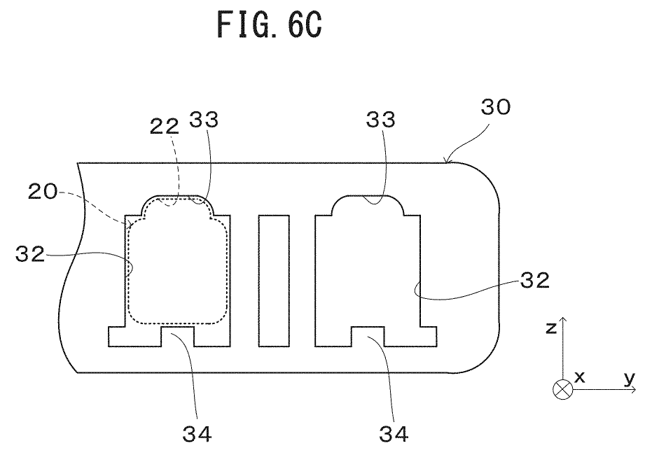

Next, with the guide groove 33 situated on the upper side (+z direction) as illustrated in FIGS. 6A to 6C, the housing 30 is fixed by the operator holding the housing 30 itself or by using a jig or the like. The terminal 20 is inserted with the correct side up, that is, with the first and second stabilizers 22 and 23 on the terminal 20 facing upward (in the +z direction), into the housing chamber 31 in the +x direction. Then, the first stabilizer 22 of the terminal 20 is guided into the guide groove 33, which is illustrated in FIG. 6C, and the first and second stabilizers 22 and 23 disposed on the terminal 20 are moved along the guide groove 33. Note that some members are omitted in FIG. 6C for convenience of explanation.

When the front end of the body 21 comes into contact with the lance 35, which is illustrated in FIG. 6B, the lance 35 is pressed downward (in the −z direction). As the terminal 20 is further advanced deep in the housing chamber 31, the recess 52 reaches the lance 35, and then the lance 35 returns to its original position. When the lance 35 returns to its original position, the lance-lock portion 24 of the terminal 20 is locked by the lance 35. As a result, the terminal 20 is prevented from being released from the housing 30.

Next, when the hinge 36a of the housing 30 is folded, the holding portion 37 disposed on the arm 36 holds the lock portion 25 of the terminal 20, as illustrated in FIG. 1B. The production of the electrical connector 100 is now finished.

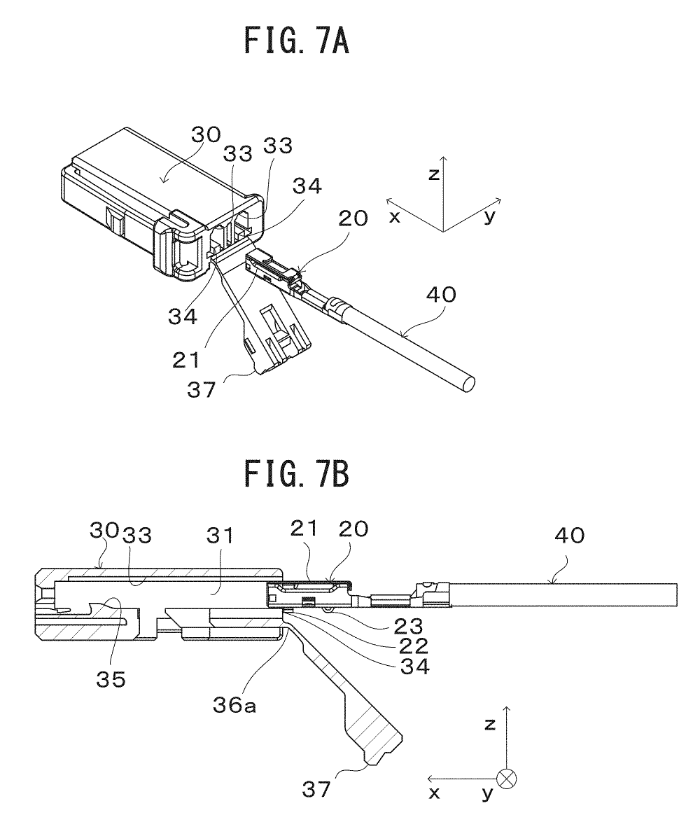

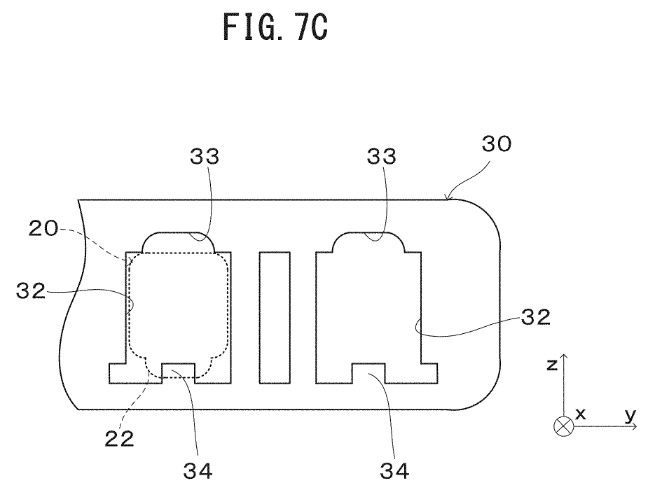

The following describes the case where the terminal 20 is inserted upside down into the housing 30, referring to FIGS. 7A to 7C.

The housing 30 is fixed with the guide groove 33 situated on the upper side (+z direction) by using a jig or the like. Then, the terminal 20 turned upside down is inserted into the housing chamber 31 in the +x direction, with the first and second stabilizers 22 and 23 on the terminal 20 facing downward (in the −z direction). In this case, the first stabilizer 22 disposed on the terminal 20 interferes with the inverse insertion preventing portion 34, as illustrated in FIGS. 7B and 7C, with the result that the terminal 20 can no longer be inserted into the housing chamber 31. Note that some members are omitted in FIG. 7C for convenience of explanation.

The electrical connector 100 as configured above includes the guide groove 33 in the housing 30, enabling the terminal 20 to be inserted with the correct side up deep into the end of the housing chamber 31, while the first and second stabilizers 22 and 23 are allowed to move along the guide groove 33. When the terminal 20 is inserted deep into the end, the lance-lock portion 24 of the terminal 20 is locked by the lance 35. As a result, the terminal 20 is prevented from being released from the housing 30. Therefore, the operator can easily assemble the electrical connector 100 by inserting the terminal 20 with the correct side up into the housing 30.

The electrical connector 100 includes the inverse insertion preventing portion 34, which is disposed at the insertion point 32 of the housing chamber 31 to abut on the first stabilizer 22 facing downward. Hence, when the assembly operator attempts to insert the terminal 20 turned upside down into the housing chamber 31, the first stabilizer 22 abuts on the inverse insertion preventing portion 34, and thus the terminal 20 can no longer be inserted into the housing chamber 31. Therefore, the terminal 20 turned upside down is prevented from being inserted.

In addition, the first and second stabilizers 22 and 23 disposed on the terminal 20 enable the terminal 20 to be in a stable posture after inserted into the housing 30. Furthermore, the holding portion 37 included in the housing 30 holds the lock portion 25 of the terminal 20, thereby preventing the terminal 20 from being released from the housing 30 more reliably.

(Variations)

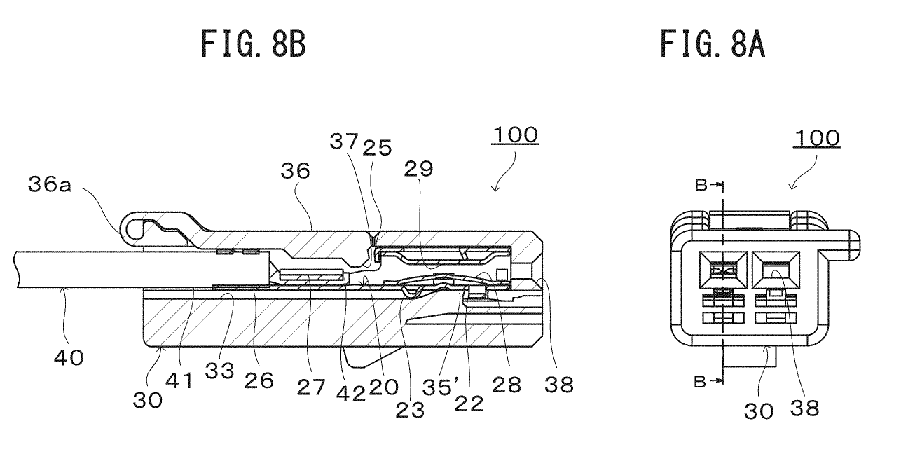

In the example described in the above embodiment, the lance 35 is disposed on the inner wall of the housing 30 to lock the lance-lock portion 24 disposed on the terminal 20. However, the lance 35 may lock any portion other than the lance-lock portion 24 as long as the lance 35 prevents the terminal 20 from being released from the housing 30. For example, as illustrated in FIG. 8B, a lance 35′ may be disposed on the guide groove 33 in the housing chamber 31 of the housing 30. In this case, the lance 35′ locks the first stabilizer 22. In this variation, the lance-lock portion 24 may not necessarily be disposed on the terminal 20.

In the example described in the above embodiment, the inverse insertion preventing portion 34 and the hinge 36a are separately disposed. However, the hinge 36a may serve as an inverse insertion preventing portion in such a way that the hinge 36a is positioned to interfere with the first stabilizer 22 when the terminal 20 turned upside down is inserted into the housing chamber 31. In this way, the housing 30 can include a portion serving as an inverse insertion preventing portion without increasing the size of the housing 30.

In the example described in the above embodiment, the terminal 20 includes two stabilizers (the first and second stabilizers 22 and 23). However, the terminal 20 may include at least one stabilizer, and may include three or more stabilizers.

In the example described in the above embodiment, the body 21 of the terminal 20 is in a square-tubular shape. However, the body 21 of the terminal 20 is not limited to any specific shape, and may not only be square but also be circular, oval, semicircular, rectangular, triangular, pentagonal, hexagonal, or any other shape in cross-section perpendicular to the axial center A of the body 21.

In the example described in the above embodiment, the terminal 20 is a female terminal. However, the terminal 20 may be a male terminal, or may be a Y-lug, O-lug, or similar terminal.

In the example described in the above embodiment, the electrical connector 100 includes a pair of terminals 20 and the housing 30 having a pair of housing chambers 31. However, the number of terminals 20 and the number of housing chambers 31 included in the electrical connector 100 are not limited to any specific number. Thus, the electrical connector 100 may include one terminal 20 and a housing 30 having one housing chamber 31, or may include three or more terminals 20 and a housing 30 having three or more housing chambers 31.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be applied to an electrical connector used as a component of an electrical circuit.

What is claimed is:

1. An electrical connector comprising: a housing that includes a tubular housing chamber;
and a terminal that is placed in the housing chamber,
wherein the terminal comprises a protrusion protruding in a direction orthogonal to a direction in which the terminal is inserted into the housing chamber,
wherein the housing comprises: a guide groove that is disposed on an inner wall of the housing chamber and that guides the protrusion when the terminal is inserted into the housing chamber; and an inverse insertion preventing portion that interferes with the protrusion when the terminal is inserted upside down into the housing chamber, and
wherein the inverse insertion preventing portion is disposed at an insertion point through which the terminal is inserted into the housing chamber.

2. The electrical connector according to claim 1, wherein
the terminal comprises a body to be in contact with a mating terminal,
the housing chamber comprises the guide groove extending in an insertion direction, and
the protrusion is disposed on the body.

3. The electrical connector according to claim 1, wherein a plurality of the protrusions is placed along a direction in which the terminal is inserted.

4. The electrical connector according to claim 1, wherein
the terminal comprises a lance-lock portion,
the housing comprises a lance protruding from an inner wall of the housing chamber, and
the lance locks the lance-lock portion when the terminal is inserted into the housing chamber.

5. The electrical connector according to claim 1, wherein
the housing comprises a lance protruding from the guide groove in the housing chamber, and
the lance locks the protrusion when the terminal is inserted into the housing chamber.
